(19) United States
(12) Patent Application Publication
(10) Pub. No.: US 2022/0156826 A1
(43) Pub. Date: May 19, 2022

(54) SYSTEMS AND METHODS FOR ESTIMATION OF LOYALTY VALUES USING DE- RANDOMIZATION

(71) Applicant: Walmart Apollo, LLC, Bentonville, AR (US)

(72) Inventors: Amit AGARWAL, Bangalore (IN); Chepuri Shri KRISHNA, Bangalore (IN); Tarun BALOTIA, Bangalore (IN)

(21) Appl. No.: 17/098,017

(22) Filed: Nov. 13, 2020

(51) Int. Cl. G06Q 30/06; G06Q 30/02

(52) U.S. Cl. CPC G06Q 30/0643; G06Q 30/0204; G06Q 30/0201; G06Q 30/0629

(57) ABSTRACT

Systems and methods for loyalty estimation are disclosed. A set of assortments each including a subset of a plurality of items is received and a loyalty score is calculated for each item in the plurality of items. The loyalty value is calculated based on a relationship between assortments including the item and assortments without the item. At least one rule is generated based on the calculated loyalty scores for at least one item in the plurality of items

### TECHNICAL FIELD

This application relates generally to low frequency modeling and, more particularly, modeling of loyalty values in low frequency data.

### BACKGROUND

Loyalty estimation is an attempt to identify affinity between purchasers and certain attributes of products. For example, purchasers may have an affinity for certain colors, features, brands, other attributes, or combinations thereof. Loyalty estimation may be used to design or build assortments of products, for example, in a retail setting. In some instances, customers may move to a different retailer if high loyalty items are not available within an assortment of products.

Current loyalty estimation systems employ methods of estimating customer churn (i.e., the percentage of customers who stop using a product or service during a certain time frame). However, churn-based loyalty estimation works only when the frequency of purchase of an item is high and is not applicable to “once in a lifetime” purchases such as furniture, electronics, vehicles, etc.

### SUMMARY

In various embodiments, a system is disclosed. The system includes a non-transitory memory having instructions stored thereon and a processor configured to read the instructions. The processor is configured to receive a set of assortments each including a subset of a plurality of items and calculate a loyalty score for each item in the plurality of items. The loyalty value is calculated based on a relationship between assortments including the item and assortments without the item. The processor is further configured to generate at least one rule based on the calculated loyalty score for at least one item in the plurality of items.

In various embodiments, a non-transitory computer readable medium having instructions stored thereon is disclosed. The instructions, when executed by a processor cause a device to perform operations including receiving a set of assortments each including a subset of a plurality of items and calculating a loyalty score for each item in the plurality of items. The loyalty value is calculated based on a relationship between assortments including the item and assortments without the item. The instructions, when executed by the processor, further cause the device to perform operations including generating at least one rule based on the calculated loyalty scores for at least one item in the plurality of items.

In various embodiments, a computer-implemented method is disclosed. The computer-implemented method includes the steps of receiving a set of assortments each including a subset of a plurality of items, calculating a loyalty score for each item in the plurality of items, and generating at least one rule based on the calculated loyalty scores for at least one item in the plurality of items. The loyalty value is calculated based on a relationship between assortments including the item and assortments without the item.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a nuclear imaging system, in accordance with some embodiments.

FIG. 2 illustrates a block diagram of a computer system, in accordance with some embodiments.

FIG. 3 is a flowchart illustrating a method of generating loyalty-based rules, in accordance with some embodiments.

FIG. 4 is a process flow illustrating various steps of the method of generating loyalty-based rules illustrated in FIG. 3, in accordance with some embodiments

FIGS. 5A-5D illustrate assortments of items, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. In the claims, means-plus-function clauses, if used, are intended to cover structures described, suggested, or rendered obvious by the written description or drawings for performing the recited function, including not only structure equivalents but also equivalent structures.

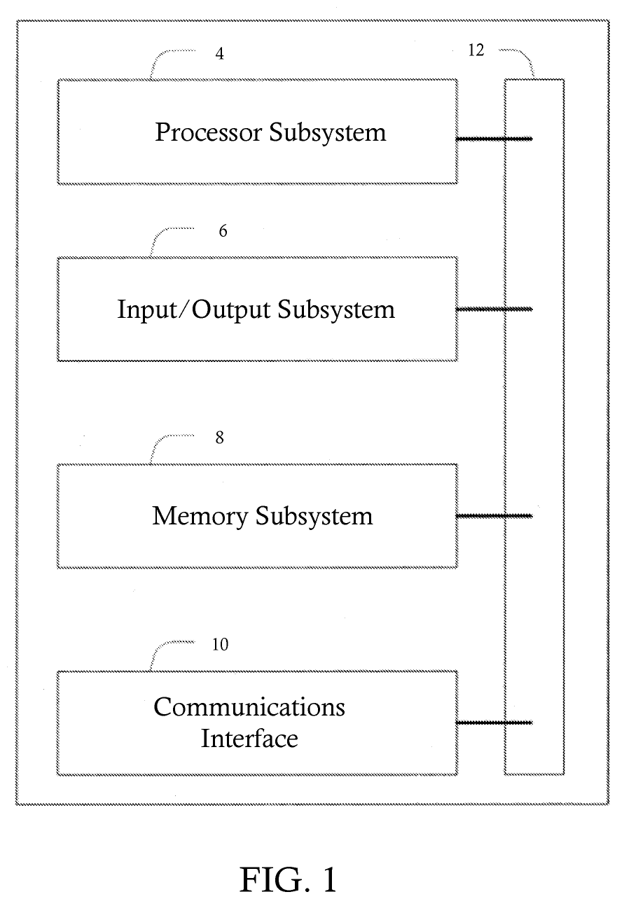

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C #, Python, Objective-C, Visual Basic, or .NET programming. In some embodiments a compiler or interpreter is comprised to convert the instruction set into machine executable code for execution by the processing subsystem 4.

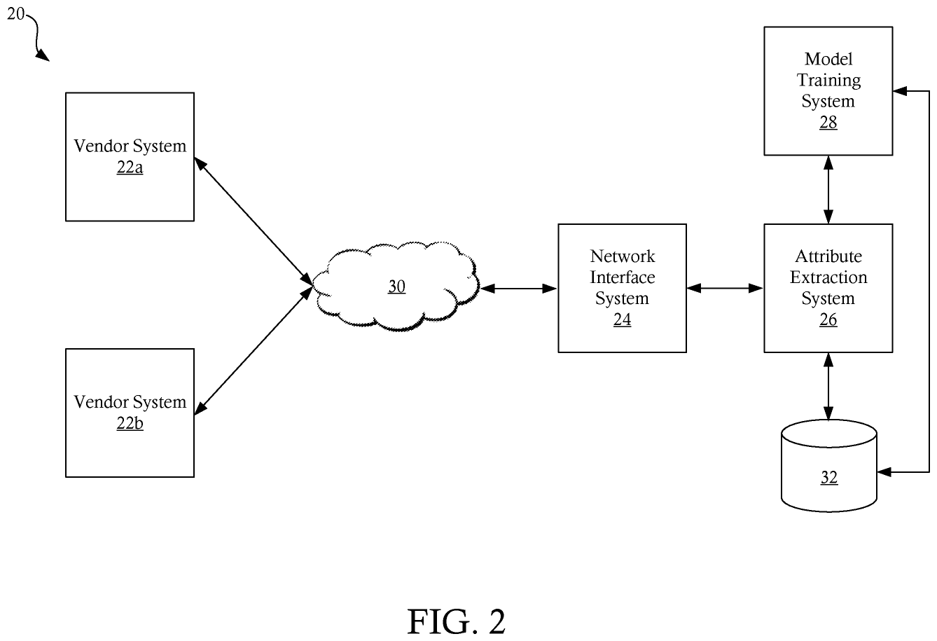

FIG. 2 illustrates a network environment 20 configured to perform loyalty analysis, in accordance with some embodiments. The network environment 20 may include, but is not limited to, one or more customer systems 22a-22b, one or more interaction systems 24a-24b, at least one network (or frontend) interface system 26, at least one loyalty analysis system 28, and at least one loyalty application system 30. Each of the customer systems 22a-22b, interaction systems 24a-24b, network interface system 26, loyalty analysis system 28, and/or loyalty application system 30 may include a system as described above with respect to FIG. 1. Although embodiments are illustrates herein having discrete systems, it will be appreciated that one or more of the illustrated systems may be combined into a single system configured to implement the functionality and/or services of each of the combined systems. For example, although embodiments are illustrated and discussed herein including each of a network interface system 26, a loyalty estimation system 28, and a loyalty application system 30, it will be appreciated that these systems may be combined into a single logical and/or physical system configured to perform the functions and/or provide services associated with each of the individual systems. It will also be appreciated that each of the illustrated systems may be replicated and/or split into multiple systems configured to perform similar functions and/or parts of a function.

In some embodiments, each of the plurality of customer systems 22a-22b is configured to interact with the network interface system 26 to perform one or more actions. For example, in some embodiments, the network interface system 26 is configured to provide an e-commerce interface and the plurality of customer systems 22a-22b are configured to perform one or more e-commerce interactions, such as, for example, performing purchase transactions, browsing products, providing customer preference information, and/or otherwise interacting with the e-commerce interface. Although embodiments are discussed herein including an e-commerce interface, it will be appreciated that the network interface system 26 can include any suitable interface configured to provide interactions with customer systems 22a-22b that include interactions with measurable loyalty values.

In some embodiments, each of the interaction systems 24a-24b are configured to provide data to the network interface system 26. For example, in some embodiments, the interaction systems 24a-24b include systems configured to generate customer records based on customer interactions with one or more retail avenues, such as, for example, brick-and-mortar purchases, online purchases, and/or otherwise providing customer records or purchase records including attributes of various products or services.

In some embodiments, the loyalty estimation system 26 is configured to implement one or more processes for estimating loyalty values for customer records. As used herein, the term “customer loyalty” refers to the percentage of customers of a product or attribute who will not purchase any substitute when the product or specific attribute of a product is not available for purchase. The customer records may include records associated with each of the customer systems 22a-22b and/or records for customers associated with other systems or interactions. In some embodiments, customer records may be stored in a database, such as database 30. In the context of an e-commerce environment, each of the customer records may include purchase histories including attributes associated with each of the purchased products. For example, customer records may include attributes such as color, brand, size, category, etc.

As discussed in greater detail below, the loyalty estimation system 26 is configured to perform a loyalty estimation for one or more of the customer records contained in the database 30. The loyalty estimation is performed by modeling a loyalty function while minimizing variance of the average result to provide trustworthy and robust results. In some embodiments, a smart averaging method is applied that reduces variance in the average. The loyalty estimation system 26 is configured to provide loyalty estimation for both high-frequency and low-frequency items represented in the customer records. Loyalty calculations can include any suitable calculation, such as, for example, loyalty of a product for a specific geographic region, demographic, season, etc. In some embodiments, the calculations are geographically and seasonally invariant.

In some embodiments, the loyalty calculations are performed by a trained model configured to implement the loyalty estimation methods discussed herein. The trained model may include any suitable machine learning model, such as a neural network, configured to implement a loyalty estimation method. In some embodiments, the machine learning model is trained based on a set of training data including a plurality of customer records each including products and associated attributes. The set of training data may also include seed loyalty values, sets of assortments having success and/or failure rates, and/or any other suitable data configured to train a machine learning model to perform loyalty calculations according to the methods discussed herein.

In some embodiments, a loyalty application system 28 is configured to generate one or more product assortments based on the loyalty calculations performed by the loyalty calculation system 26. For example, in various embodiments, the loyalty application system 28 may be configured to generate assortments for brick-and-mortar retail locations, such as, for example, optimizing shelf assortments for shelves, aisles, and/or entire stores of a specific brick-and-mortar retail location, provide local assortment recommendations for pairing of products, generate seasonal sales plans or focuses, special edition sales, and/or any other suitable assortment combination.

As another example, in some embodiments, the loyalty application system 28 is configured to generate or analyze information related to an e-commerce interface or frontend. For example, in some embodiments, the loyalty application system 28 may generate information regarding product or provider (e.g., seller) depth regarding various high-loyalty items, seasonal decisions including product stocking, marketing, website presentation, etc., and/or any other suitable analysis. In some embodiments, the e-commerce frontend may utilize assortment calculations similar to those discussed above with respect to brick-and-mortar stores. Similarly, the brick-and-mortar stores may utilize analysis discussed in the context of an e-commerce interface.

As yet another example, in some embodiments, the loyalty application system 28 is configured to generate input to an ordering application, such as a food (or delivery) application. The loyalty application system 28 may provide information regarding an affinity to certain restaurants or dishes for specific customers (or groups of customers) based on loyalty calculations, optimizes listings for low-frequency orders within the ordering application, and/or perform any other grouping or ordering of content within the application based on the loyalty scores calculated by the loyalty estimation system 26.

As still another example, in some embodiments, the loyalty application system 28 is configured to generate “holiday marketplaces,” i.e., offerings (brick-and-mortar, e-commerce, etc.) for travel to various locals. Customizable factors may include, but are not limited to, holiday duration (e.g., identifying shorter trips for non-holiday periods (off-seasons)), general geography (e.g., colder climates, hotter climates, local language, etc.), or specific geography (e.g., countries, cities, or other specific locations). Although embodiments are discussed herein with specific loyalty applications, it will be appreciated that the loyalty calculation methods and systems discussed herein can be applied to any suitable environment in which customer (or user) loyalty can be calculated for specific attributes of products, services, or other interactions.

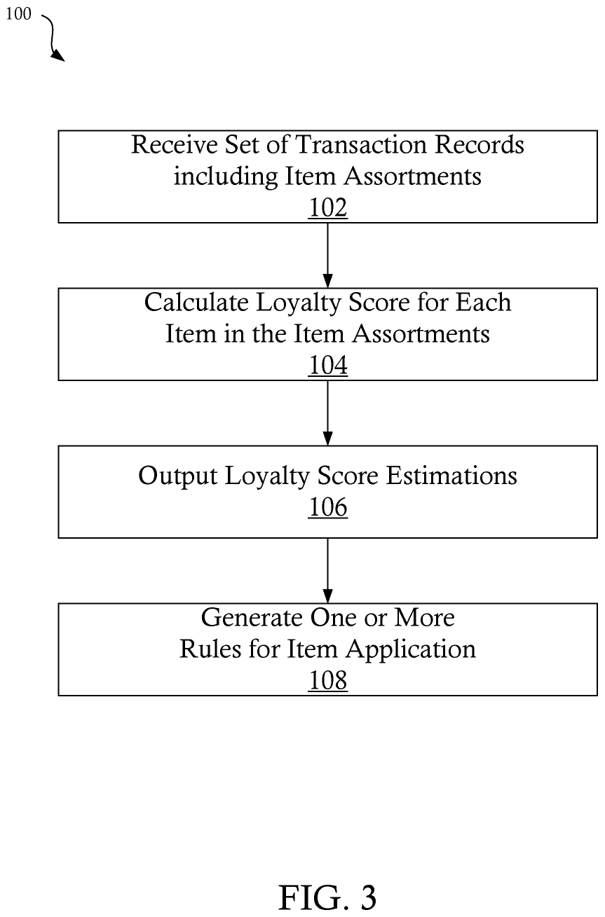

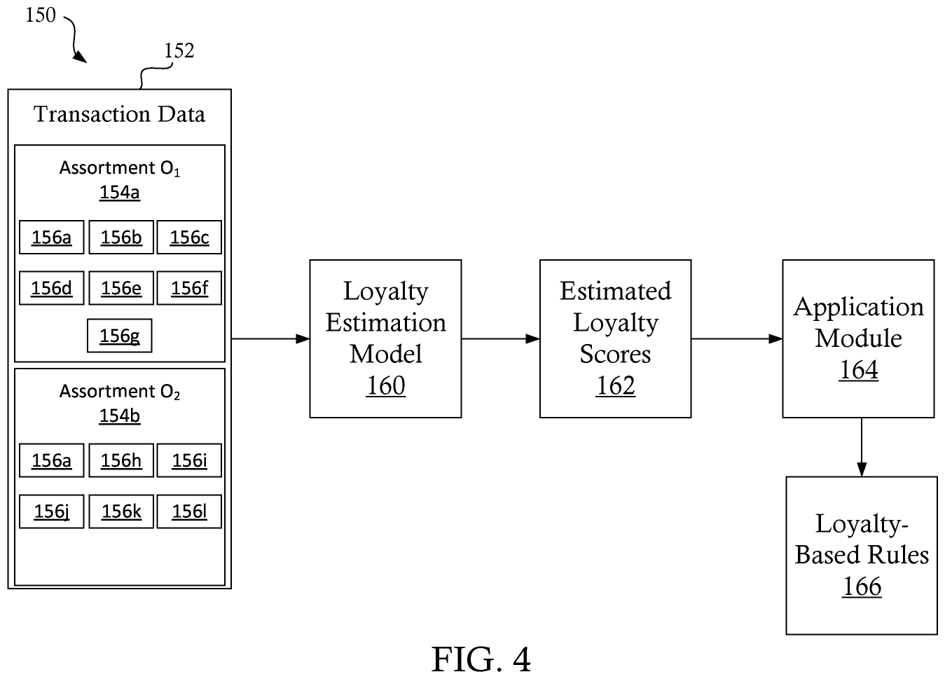

FIG. 3 is a flowchart 100 illustrating a method of generating loyalty-based rules, in accordance with some embodiments. FIG. 4 is a process flow 150 illustrating various steps of the method of generating loyalty-based rules illustrated in FIG. 3, in accordance with some embodiments. At step 102, a set of transaction records 152 are received by a system configured to perform loyalty estimation, such as, for example, a loyalty estimation system 28. The transaction records 152 include assortments 154a-154b, each containing a plurality of items 156a-156l. Each of the items 156a-156l may represent, for example, a product or service available through one or more retail channels. The transaction records 152 may also include customer records, purchase records, product records, and/or any other suitable records including data related to customer interactions with the assortments 154a-154b and/or individual items 156a-156l within the assortments 154a-154b. Each item in each of the assortments may include one or more attributes.

At step 104, a loyalty score for each item 156a-156l within each assortment 154a-154b in the transaction records 152 is calculated by a loyalty estimation model 160. The loyalty score is estimated based on a relationship between sales of an assortment 154a-154b including a specific item 156a-156l, sales of an assortment 154a-154b without the specific item, and customer interactions with the specific item 156a-156l.

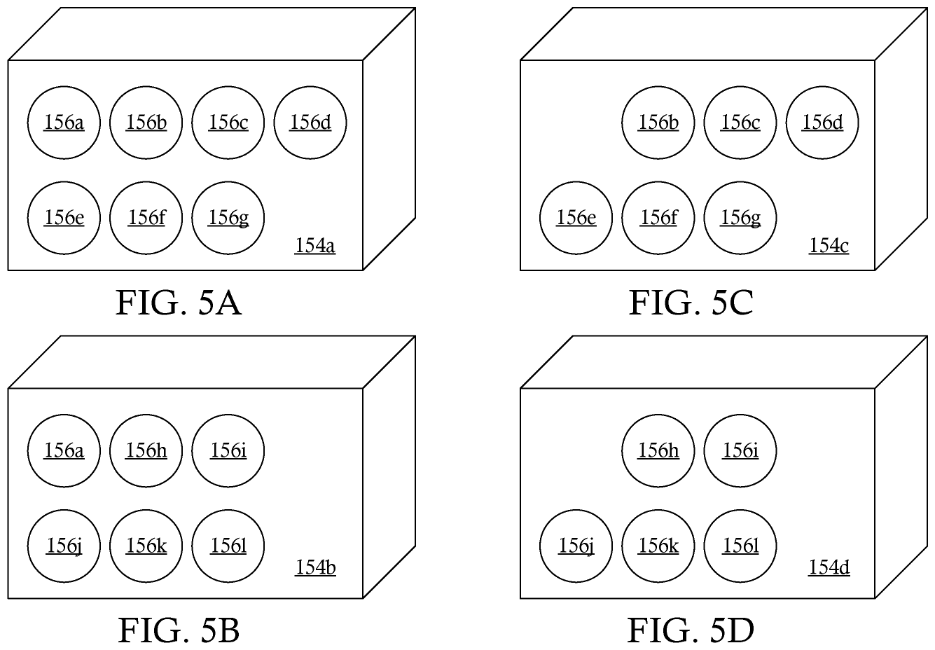

For example, FIGS. 5A and 5B illustrate assortments 154a, 154b of a set of items 154a-154l, in accordance with some embodiments. FIG. 5C illustrates the assortment 154a of FIG. 3A after removing a first item 156a and FIG. 3D illustrates the assortment 154b of FIG. 3B after removing the first item 156a.

Loyalty estimation with respect to a first item 102a, referred to herein as item A, may be denoted as Loyalty(A) and the loyalty of item A given an assortment pair (O, O^{A}) is denoted as Loyalty(A, O), where O is an assortment 154a, 154b including the first item 102a and O^{A} denotes an assortment O after removing the first item 102a (e.g., assortments 154c, 154d illustrated in FIGS. 3C and 3D, respectively). The loyalty of item A given the assortment pair (O, O^{A}) may be calculated as:

$$Loyalty ( A , O ) = \frac{S ( O ) - S ( {O}^{A} )}{S ( A , O )}$$

wherein S(O) is the total sales for the assortment O, S(O^{A}) is the sales for assortment O without item A, and S(A, O) is the total sales for the assortment when item A was included in the assortment.

In order to determine the loyalty of item A generally, a calculation may be performed for multiple assortments which contain item A. In some embodiments, a loyalty calculation is performed for every assortment 154a-154b containing item A within the set of transaction data 152. The loyalty calculation for an assortment including item A may be generalized as:

$$Loyalty ( A , {O}_{i} ) = \frac{S ( {O}_{i} ) - S ( {O}_{i}^{A} )}{S ( A , {O}_{i} )}$$

where, Oᵢ is the i^{th} assortment containing item A. A subset (Oⱼ) of the assortments including item A may be selected. For example, a random sample of the assortments 154a-154b including item A may be performed. In other embodiments, assortments may be selected based on one or more predetermined criteria, such as, for example, minimum sales of the assortment, minimum sales of item A, etc. The loyalty estimations for each assortment in the subset, Loyalty(A, Oⱼ) may be weighted by the total sales of A in that assortment, S(A, Oⱼ), to give a total loyalty of item A:

$$Loyalty ( A ) = \frac{{\sum }_{i = 1}^{n} S ( A , {O}_{i} ) * Loyalty ( A , {O}_{i} )}{{\sum }_{i = 1}^{n} S ( A , {O}_{i} )}$$

which can be simplified to:

$$Loyalty ( A ) = \frac{{\sum }_{i = 1}^{n} S ( {O}_{i} ) - S ( {O}_{i}^{A} )}{{\sum }_{i = 1}^{n} S ( A , {O}_{i} )}$$

In various embodiments, the loyalty for each item 156a-156l included in any of the assortments 154a-154b may be calculated.

In one example, a loyalty calculations for a set of products included in various retail assortments was performed according to the disclosed method and compared to traditional loyalty estimations. As shown in the below chart, the loyalty estimations performed using the disclosed system and method (denoted as “Loyalty Score”) provide greater accuracy, less variance, and a higher reliability than loyalty estimations performed using traditional methods (denoted as “Traditional Score”):

| Product | Brand | Loyalty Score | Traditional Score |
|---|---|---|---|
| Item A | X | 0.62 | 0.11 |
| Item B | Y | 0.50 | −0.04 |
| Item C | X | 0.54 | 0.09 |
| Item D | Z | 0.58 | 0.00 |
| Item E | X | 0.70 | −0.01 |
| Item F | X | 0.53 | −0.25 |
| Item G | Z | 0.70 | 0.00 |
| Item H | X | 0.54 | 0.04 |
| Item I | X | 0.39 | 0.26 |
| Item J | Z | 0.40 | 0.00 |
| Item K | W | 0.82 | 0.00 |
| Item L | X | 0.36 | 0.15 |

For example, as illustrated in the above chart, the traditional method was capable of producing negative loyalty values which do not represent brand loyalty. In contrast, the method disclosed herein product positive values for the same products and therefore represent actual attribute loyalty. Similarly, the loyalty for various products of the same brand have less variance as compared to the traditional score and therefore more accurately represent brand loyalty.

In some embodiments, an additional weighted averaging method may be applied to the calculated loyalty scores. The weights used in the weighted averaging method may include values that capture product interactions in retail and/or e-commerce stores. For example, in various embodiments, weighted averages may include weights for frequency of purchase, number of people purchasing the products, repeat purchases by the same user, etc.

At step 106, a set of loyalty score estimations 162 is output by the loyalty estimation model 160 and provided to an application module 164. The application module is configured to generate one or more loyalty-based rules for an application configured to provide access to the items 156a-156l within the assortments 154a-154b based on the received loyalty estimations. For example, in various embodiments, the application module 164 may be configured to generate rules regarding: retail and/or e-commerce stores, such as optimized shelf assortments, local assortment recommendations, seasonal sale information, special edition sale information; e-commerce market places, such as seller depth requirements, seasonal sales decisions, etc.; food ordering applications or marketplaces, such as restaurant and/or dish presentation or recommendations, menu or listing optimizations, etc.; holiday marketplace offerings, such as linking holiday offerings to estimated holiday periods, geographical holiday offerings, etc.; and personalization of recommendations with respect to specific operating locations, time periods, etc. Although specific rules and/or applications are discussed herein, it will be appreciated that the application module 164 may apply the loyalty calculations to any suitable application including the items 156a-156l.

For example, in some embodiments, the application module 164 is configured to generate an optimized shelf assortment for a subset of the products included in the plurality of items 156a-156l within a retail environments. The application module 164 may apply a rule regarding placement of the subset of products based on estimated loyalty scores, such as, for example, placing products having high estimated loyalty scores in visible and/or high-traffic areas and products having lower estimated loyalty scores in less visible and/or low-traffic locations. By placing high loyalty products in high visibility locations, the application module 164 may ensure that customers identify the availability of high loyalty products quickly and avoid the customer going to a different source due to not being able to find a high loyalty product.

As another example, in some embodiments, provide local assortment recommendations for pairing of products, generate seasonal sales plans or focuses, special edition sales, and/or any other suitable assortment combination.

As another example, in some embodiments, the loyalty application system 28 is configured to generate or analyze information related to an e-commerce interface or frontend. For example, in some embodiments, the loyalty application system 28 may generate information regarding product or provider (e.g., seller) depth regarding various high-loyalty items, seasonal decisions including product stocking, marketing, website presentation, etc., and/or any other suitable analysis. In some embodiments, the e-commerce frontend may utilize assortment calculations similar to those discussed above with respect to brick-and-mortar stores. Similarly, the brick-and-mortar stores may utilize analysis discussed in the context of an e-commerce interface.

As yet another example, in some embodiments, the loyalty application system 28 is configured to generate input to an ordering application, such as a food (or delivery) application. The loyalty application system 28 may provide information regarding an affinity to certain restaurants or dishes for specific customers (or groups of customers) based on loyalty calculations, optimizes listings for low-frequency orders within the ordering application, and/or perform any other grouping or ordering of content within the application based on the loyalty scores calculated by the loyalty estimation system 26.

As still another example, in some embodiments, the loyalty application system 28 is configured to generate “holiday marketplaces,” i.e., offerings (brick-and-mortar, e-commerce, etc.) for travel to various locals. Customizable factors may include, but are not limited to, holiday duration (e.g., identifying shorter trips for non-holiday periods (off-seasons)), general geography (e.g., colder climates, hotter climates, local language, etc.), or specific geography (e.g., countries, cities, or other specific locations). Although embodiments are discussed herein with specific loyalty applications, it will be appreciated that the loyalty calculation methods and systems discussed herein can be applied to any suitable environment in which customer (or user) loyalty can be calculated for specific attributes of products, services, or other interactions.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory having instructions stored thereon and a processor configured to read the instructions to:
receive a set of assortments each including a subset of a plurality of items;
calculate a loyalty score for each item in the plurality of items, wherein the loyalty value is calculated based on a relationship between assortments including the item and assortments without the item; and
generate at least one rule based on the calculated loyalty score for at least one item in the plurality of items.

2. The system of claim 1, wherein the loyalty score for an item A in an assortment O is calculated according to the equation:
$$Loyalty ( A , O ) = \frac{S ( O ) - S ( {O}^{A} )}{S ( A , O )}$$
where Loyalty(A,O) is the loyalty score of item A in the assortment O, S(O) is the total sales for the assortment O, S(O^{A}) is the sales for assortment O without item A, and S(A, O) is the total sales for the assortment O when item A was included in the assortment.

3. The system of claim 1, wherein the loyalty score for of an item A in the set of assortments may be weighted by a total sales of the item A in the assortment Oᵢ according to the equation:
$$Loyalty ( A ) = \frac{{\sum }_{i = 1}^{n} S ( A , {O}_{i} ) * Loyalty ( A , {O}_{i} )}{{\sum }_{i = 1}^{n} S ( A , {O}_{i} )}$$
where Loyalty(A) is the loyalty score of item A, S(A, Oᵢ) is the total sales for the assortment O, when item A was included in the assortment Oᵢ, Loyalty(A,Oᵢ) is the loyalty score of item A in the assortment Oᵢ, and n is less than or equal to a number of assortments in the set of assortments.

4. The system of claim 1, wherein the loyalty score for an item A (Loyalty(A)) maybe calculated according to the equation:
$$Loyalty ( A ) = \frac{{\sum }_{i = 1}^{n} S ( {O}_{i} ) - S ( {O}_{i}^{A} )}{{\sum }_{i = 1}^{n} S ( A , {O}_{i} )}$$
where S(Oᵢ) is the total sales for the assortment Oᵢ, S(Oᵢ^{A}) is the sales for assortment Oᵢ without item A, and S(A, Oᵢ) is the total sales for the assortment O when item A was included in the assortment.

5. The system of claim 1, wherein the at least one rule comprises a rule for placement of products in a retail setting.

6. The system of claim 1, wherein the at least one rule comprises a rule requiring a predetermined number of sellers of an item in an e-commerce environment.

7. The system of claim 1, wherein the at least one rule comprises a rule for presenting the plurality of items in an e-commerce environment arranged according to loyalty score.

8. A non-transitory computer readable medium having instructions stored thereon, wherein the instructions, when executed by a processor cause a device to perform operations comprising:
receiving a set of assortments each including a subset of a plurality of items;
calculating a loyalty score for each item in the plurality of items, wherein the loyalty value is calculated based on a relationship between assortments including the item and assortments without the item; and
generating at least one rule based on the calculated loyalty scores for at least one item in the plurality of items.

9. The non-transitory computer readable medium of claim 8, wherein the loyalty score for an item A in an assortment O is calculated according to the equation:
$$Loyalty ( A , O ) = \frac{S ( O ) - S ( {O}^{A} )}{S ( A , O )}$$
where Loyalty(A,O) is the loyalty score of item A in the assortment O, S(O) is the total sales for the assortment O, S(O^{A}) is the sales for assortment O without item A, and S(A, O) is the total sales for the assortment O when item A was included in the assortment.

10. The non-transitory computer readable medium of claim 8, wherein the loyalty score for of an item A in the set of assortments may be weighted by a total sales of the item A in the assortment Oᵢ according to the equation:
$$Loyalty ( A ) = \frac{{\sum }_{i = 1}^{n} S ( A , {O}_{i} ) * Loyalty ( A , {O}_{i} )}{{\sum }_{i = 1}^{n} S ( A , {O}_{i} )}$$
where Loyalty(A) is the loyalty score of item A, S(A, Oᵢ) is the total sales for the assortment Oᵢ when item A was included in the assortment Oᵢ, Loyalty(A,Oᵢ) is the loyalty score of item A in the assortment Oᵢ, and n is less than or equal to a number of assortments in the set of assortments.

11. The non-transitory computer readable medium of claim 8, wherein the loyalty score for an item A (Loyalty(A)) maybe calculated according to the equation:
$$Loyalty ( A ) = \frac{{\sum }_{i = 1}^{n} S ( {O}_{i} ) - S ( {O}_{i}^{A} )}{{\sum }_{i = 1}^{n} S ( A , {O}_{i} )}$$
where S(Oᵢ) is the total sales for the assortment Oᵢ, S(Oᵢ^{A}) is the sales for assortment Oᵢ without item A, and S(A, Oᵢ) is the total sales for the assortment O when item A was included in the assortment.

12. The non-transitory computer readable medium of claim 8, wherein the at least one rule comprises a rule for placement of products in a retail setting.

13. The non-transitory computer readable medium of claim 8, wherein the at least one rule comprises a rule requiring a predetermined number of sellers of an item in an e-commerce environment.

14. The non-transitory computer readable medium of claim 8, wherein the at least one rule comprises a rule for presenting the plurality of items in an e-commerce environment arranged according to loyalty score.

15. A computer-implemented method comprising:
receiving a set of assortments each including a subset of a plurality of items;
calculating a loyalty score for each item in the plurality of items, wherein the loyalty value is calculated based on a relationship between assortments including the item and assortments without the item; and
generating at least one rule based on the calculated loyalty scores for at least one item in the plurality of items.

16. The computer-implemented method of claim 15, wherein the loyalty score for an item A in an assortment O is calculated according to the equation:
$$Loyalty ( A , O ) = \frac{S ( O ) - S ( {O}^{A} )}{S ( A , O )}$$
where Loyalty(A,O) is the loyalty score of item A in the assortment O, S(O) is the total sales for the assortment O, S(O^{A}) is the sales for assortment O without item A, and S(A, O) is the total sales for the assortment O when item A was included in the assortment.

17. The computer-implemented method of claim 15, wherein the loyalty score for of an item A in the set of assortments may be weighted by a total sales of the item A in the assortment O, according to the equation:
$$Loyalty ( A ) = \frac{{\sum }_{i = 1}^{n} S ( A , {O}_{i} ) * Loyalty ( A , {O}_{i} )}{{\sum }_{i = 1}^{n} S ( A , {O}_{i} )}$$
where Loyalty(A) is the loyalty score of item A, S(A, Oᵢ) is the total sales for the assortment O, when item A was included in the assortment Oᵢ, Loyalty(A,Oᵢ) is the loyalty score of item A in the assortment Oᵢ, and n is less than or equal to a number of assortments in the set of assortments.

18. The computer-implemented method of claim 15, wherein the loyalty score for an item A (Loyalty(A)) maybe calculated according to the equation:
$$Loyalty ( A ) = \frac{{\sum }_{i = 1}^{n} S ( {O}_{i} ) - S ( {O}_{i}^{A} )}{{\sum }_{i = 1}^{n} S ( A , {O}_{i} )}$$
where S(Oᵢ) is the total sales for the assortment Oᵢ, S(Oᵢ^{A}) is the sales for assortment Oᵢ without item A, and S(A, Oᵢ) is the total sales for the assortment O when item A was included in the assortment.

19. The computer-implemented method of claim 15, wherein the at least one rule comprises a rule for placement of products in a retail setting.

20. The computer-implemented method of claim 15, wherein the at least one rule comprises a rule requiring a predetermined number of sellers of an item in an e-commerce environment.
